(19) United States
(12) Patent Application Publication
(10) Pub. No.: US 2010/0103214 A1
(43) Pub. Date: Apr. 29, 2010

(54) INKJET HEAD ALIGNING METHOD

(75) Inventors: Shang-Hoon Seo, Seoul (KR); Jae-Woo Joung, Suwon-si (KR); Kyoung-Jin Jeong, Suwon-si (KR); Ro-Woon Lee, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/480,210

(22) Filed: Jun. 8, 2009

(30) Foreign Application Priority Data
Oct. 28, 2008 (KR) 10-2008-0105682

(51) Int. Cl. B41J 29/38

(52) U.S. Cl. 347/14

(57) ABSTRACT

Disclosed is a method of aligning an inkjet head. The method of aligning an inkjet head having a plurality of nozzles can include recognizing a position (x₁, y₁) of a first nozzle by using a nozzle measuring camera; recognizing a position (x₂, y₂) of a second nozzle by moving the nozzle measuring camera horizontally; calculating a tilting angle θ between the first nozzle and the second nozzle; and rotating the inkjet head according to the tilting angle. With the present invention, it is possible to easily and precisely the inkjet head having a plurality of nozzles by using the inkjet head and optical devices.

### CROSS-REFERENCE TO RELATED APPLICATIONS

This application claims the benefit of Korean Patent Application No. 10-2008-0105682, filed with the Korean Intellectual Property Office on Oct. 28, 2008, the disclosure of which is incorporated herein by reference in its entirety.

### BACKGROUND

1. Technical Field

The present invention relates to an inkjet head aligning method.

2. Description of the Related Art

With the currently growing demand for inexpensive electronic devices, development of a new method, especially an inexpensive manufacturing process to replace the photolithography process, has been increasingly required.

The conventional technology of manufacturing printed circuit boards repeatedly uses the exposure and etching processes to form electrodes and signal patterns. There are some problems on the maintenance cost of utility equipment and masks used in the exposure.

The printing technology, which mass-produces products by using the same pattern plate, can easily form conductive patterns and image patterns at a low cost. Especially, unlike the conventional gravure printing or screen printing, which requires a costly plate process, the inkjet printing technology can significantly reduce the processing cost by converting data to digital signals and performing the direct patterning. Moreover, the inkjet printing is very adequate for small quantity batch production, which is today's trend of manufacturing electronic devices.

The DoD (drop on demand) type of inkjet printer was developed and became popular as a personal printer. If this inkjet technology is applied to the manufacture of printed circuit boards, the increased packaging density of parts and the effect on the price reduction can be expected by using the environmentally friendly manufacturing process.

In the printing of various types of boards including printed circuit boards, when a board is placed on a plate, the board is conventionally aligned in X- and Y-axes of the plate by using guide pins, or the board is aligned by using a vision system in the board on which holes or align-marks are formed.

In the case of using guide pins, it is difficult to precisely align the board due to position errors, which are caused by user's manual alignment, and manufacturing errors of guide pins. In the case of inkjet boards of various sizes and materials, it is also difficult to uniformly form holes or align-marks in the boards.

A substrate board pre-align apparatus has been disclosed in Korean patent registration No. 0369398. FIG. 1 is a brief view showing the substrate board pre-align apparatus disclosed in Korean patent registration No. 0369398. The patent is related to the substrate board pre-align apparatus for aligning the boards in various forming and processing devices especially in the exposurer, in which a loading unit 1, a pre-align unit 2, and a working unit 3 for performing a desired operation such as the exposure are arranged in the lengthwise direction.

The method disclosed in the above Korean patent, however, requires complex machines, such as aligning sensors 11 and 12 for detecting a point of time when a board is passed, a reference point detecting sensor 13 for detecting a position of a board S when the board S is initially set, a position control device for controlling the position of the aligning sensors, and an image device. “C” in FIG. 1 refers to the center of the board S.

### SUMMARY

The present invention provides an inkjet printing aligning method using an optical system that is used in an inkjet head having multi-nozzles, a nozzle measurer, and a pattern measurer.

An aspect of present invention features

At this time,

$$θ = {tan}^{- 1} \frac{{y}_{2} - {y}_{1}}{{x}_{2} - {x}_{1}}$$

### BRIEF DESCRIPTION OF THE DRAWINGS

FIG. 1 is a plan view showing the conventional method of aligning an inkjet head;

FIG. 2 is a flowchart showing a method of aligning an inkjet head in accordance with an embodiment of the present invention;

FIG. 3 is a perspective view showing a system for realizing a method of aligning an inkjet head in accordance with an embodiment of the present invention; and

FIG. 4 through FIG. 6B show each process of a method of aligning an inkjet head in accordance with an embodiment of the present invention.

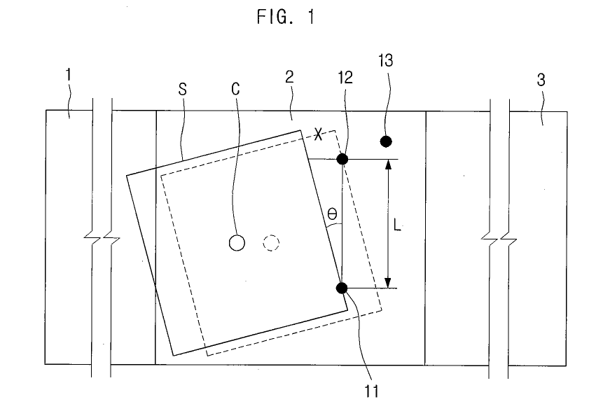

### DETAIL DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

When one element is described as being “connected” or “accessed” to another element, it shall be construed as being connected or accessed to another element directly but also as possibly having yet another element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, a method of aligning an inkjet head according to an embodiment of the present invention will be described in detail with reference to the accompanying drawings. Identical or corresponding elements will be given the same reference numerals, regardless of the figure number, and any redundant description of the identical or corresponding elements will not be repeated.

When an inkjet apparatus is studied and developed, experiments are performed by changing various heads. While the heads are manually replaced, there occur instrument errors. An embodiment of the present invention provides a method of minimizing these mounting errors.

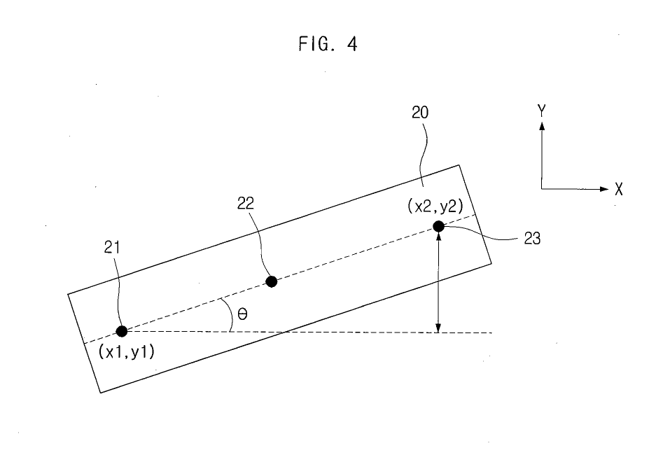

FIG. 4 shows what can happen when a head is manually mounted. Such manual mounting may make it difficult to discharge an ink droplet straight. This may reduce the distance between printed lines, and as a result, printed patterns may be different from the designed patterns or there may be defective printing. That is, the head may be moved in the rotating direction. This may cause errors in the printing in horizontal and diagonal directions.

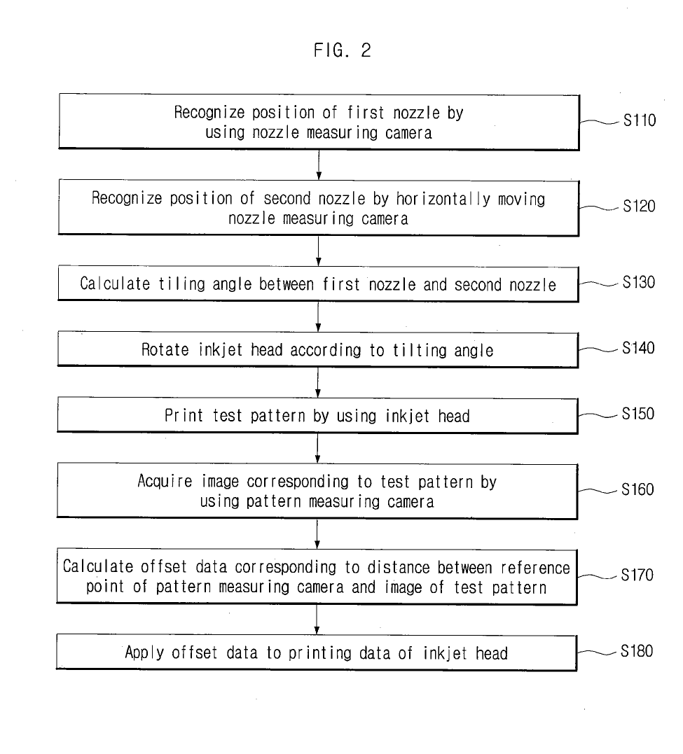

An embodiment of the present invention suggests a method of solving such a problem by calculating a tilting angle of the head, which shows how much the head is rotated, by use of a nozzle measuring camera for measuring the nozzle and then correcting an alignment error through the rotation of the head. This will be described in more detail with reference to FIG. 2 through FIG. 4.

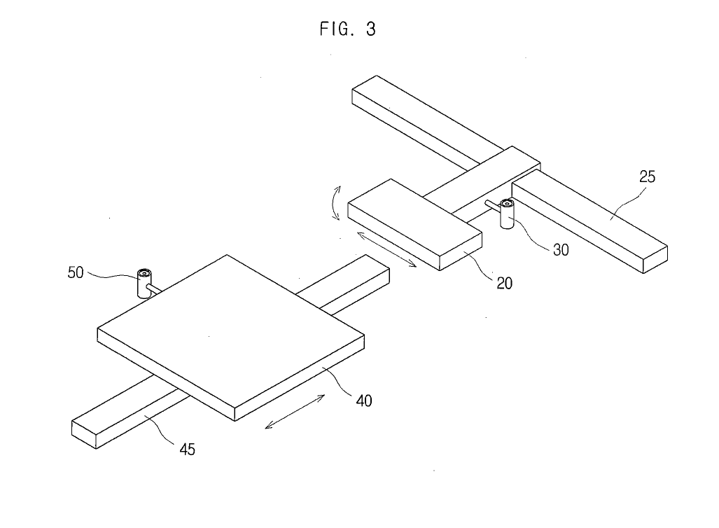

FIG. 2 is a flowchart showing a method of aligning an inkjet head in accordance with an embodiment of the present invention, and FIG. 3 is a perspective view showing a system for realizing the method of aligning an inkjet head in accordance with an embodiment of the present invention. Shown in FIG. 3 are an inkjet head 20, a guide rail 25, a pattern measuring camera 30, a plate 40, a guide rail 45, and a nozzle measuring camera 50.

Firstly, a process represented by S110 can recognize a position of a first nozzle 21 by using the nozzle measuring camera 50. The nozzle measuring camera 50 can employ a CCD camera and additionally use a magnification lens as necessary. The size of the nozzle may be considered for the magnifying power of the magnification lens.

Since it is difficult to find a fine nozzle having the size of 30 um or smaller, it is possible to use a method of firstly searching for an identifying mark (not shown) formed at a lower side of the inkjet head 20 and then searching for nozzles on the basis of the identifying mark (not shown).

After finding the first nozzle 21, a position of the first nozzle 21 can be recognized by adjusting a focusing point for precise measurement and alignment and then acquiring a coordinate value (x₁, y₁) of the first nozzle 21.

Then, a process represented by S120 can recognize a position of a second nozzle 23 by horizontally moving the nozzle measuring camera 50. That is, the process can acquire a coordinate value (x₂, y₂) of the second nozzle 23 by using the same method as that of the first nozzle 21.

Then, a process represented by S130 can calculate a tilting angle between the first nozzle 21 and the second nozzle 23. The tilting angle θ between the first nozzle 21 and the second nozzle 23 can be calculated by the following simple formula.

$$θ = {tan}^{- 1} \frac{{y}_{2} - {y}_{1}}{{x}_{2} - {x}_{1}}$$

While this embodiment of the present invention has suggested the method of calculating the tilting angle θ by using the first nozzle 21 and the second nozzle 23 of the inkjet head 20, it shall be evident that the tilting angle θ can be calculated by using the first nozzle 21 and a nozzle 22 placed in the center part.

Thereafter, a process represented by S140 can align the inkjet head 20 by rotating the inkjet head 20 according to the calculated tilting angle to correct the distorted angle.

Accordingly, it is possible to correct the instrument errors made when the inkjet head 20 is mounted, by using the inkjet head 20 and the nozzle measuring camera 50.

Hitherto, the method of correcting aligning errors in the rotating direction, which can be made when the inkjet head 20 is mounted, has been described. A method of correcting aligning errors in the direction of x-y axes will be described hereinafter. Such an x-y axes correcting method can be performed before or after the aforementioned rotating-directional aligning error correcting method.

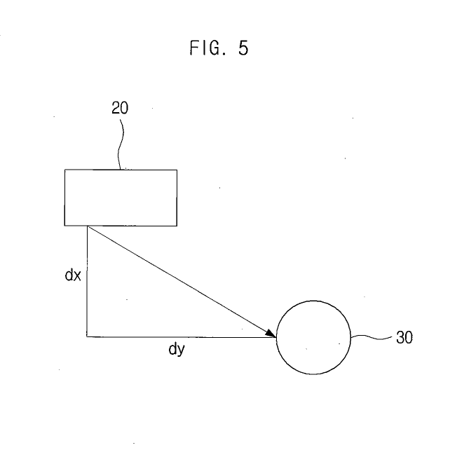

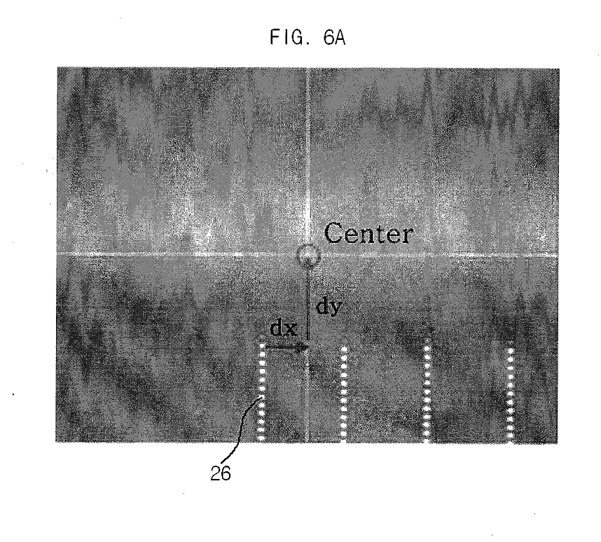

When the printing process is performed by using a printing system having the inkjet head 20, the function that is able to monitor a printed pattern in-situ can be used. At this time, the pattern measuring camera 30, as shown in FIG. 5, can maintain a regular offset distance from the inkjet head 20 instrumentally according to the initially designed size to monitor a pattern. That is, an optical device such as the pattern measuring camera 30 can be mounted at a position that is separated by dx in the X axis and dy in the Y axis from the inkjet head 20 to monitor the printed pattern.

As described above, when experiments are performed to study and develop the inkjet equipment by changing various heads, there may be instrument errors while changing the heads manually. An embodiment of the present invention provides a method of minimizing these mounting errors.

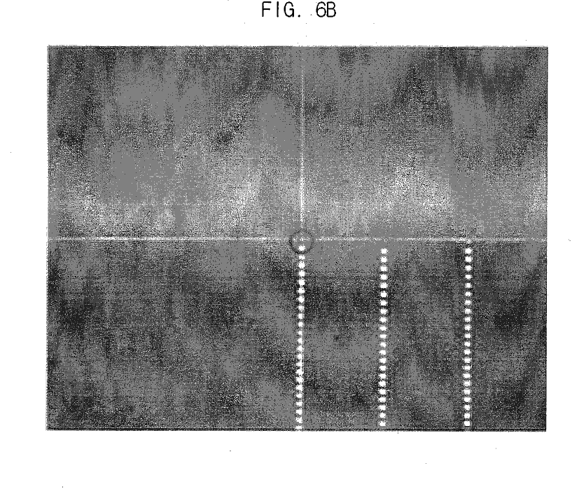

Firstly, a process represented by S150 can recognize and store a current position (Hₓ, H_{y}) of a nozzle formed in the inkjet head 20 and then print a test pattern 26 as shown in FIG. 6A.

Then, a process represented by S160 can acquire an image corresponding to the test pattern 26 by using the pattern measuring camera 30. The pattern measuring camera 30 can employ a CCD camera, for example, and additionally use a magnification lens as necessary. The size of the test pattern 26, which is a measuring target, can be considered for the magnifying power of the magnification lens. The pattern measuring camera 30 can be mounted in a module having the inkjet head 20 or in a module separated from the inkjet head 20, which is modifiable according to the configuration of the printing system.

Next, a process represented by S170 can calculate offset data (dx, dy) corresponding to a distance between the reference point (i.e. the center) of the pattern measuring camera 30 and the image of the test pattern 26. For example, when the test pattern 26 is printed, a position of the center of the pattern measuring camera 30 is stored, as shown in FIG. 6A, and the center of the pattern measuring camera 30 is moved according to the printed test pattern 26. Then, the offset data (dx, dy) can be obtained by calculating the distance by which the center of the pattern measuring camera 30 is moved.

After the offset data (dx, dy) is obtained, a process represented by S180 can apply the offset data (dx, dy) to printing data of the inkjet head 20. This is to precisely measure a printed result of the inkjet head 20 by using a pattern measurer in the printing later, by applying the offset data (dx, dy) to printing data that is inputted into the inkjet head 20 for the printing to align the inkjet head 20.

Hitherto, although a certain embodiment of the present invention has been shown and described for the above-described objects, it will be appreciated by any person of ordinary skill in the art that a large number of modifications, permutations and additions are possible within the principles and spirit of the invention, the scope of which shall be defined by the appended claims and their equivalents.

Many other embodiments can be included in the scope of claims of the present invention.

What is claimed is:

1. A method of aligning an inkjet head having a plurality of nozzles, the method comprising:
recognizing a position (x₁, y₁) of a first nozzle by using a nozzle measuring camera;
recognizing a position (x₂, y₂) of a second nozzle by moving the nozzle measuring camera horizontally;
calculating a tilting angle θ between the first nozzle and the second nozzle; and
rotating the inkjet head according to the tilting angle.

2. The method of claim 1, wherein the calculating of the tilting angle is performed by using the following formula.
$$θ = {tan}^{- 1} \frac{{y}_{2} - {y}_{1}}{{x}_{2} - {x}_{1}}$$

3. The method of claim 1, further comprising:
printing a test pattern by using the inkjet head;
obtaining an image corresponding to the test pattern by using the pattern measuring camera;
calculating offset data corresponding to a distance between a reference point of the pattern measuring camera and the image corresponding to the test pattern; and
applying the offset data to printing data of the inkjet head.
